(19) United States
(12) Patent Application Publication
(10) Pub. No.: US 2009/0308220 A1
(43) Pub. Date: Dec. 17, 2009

(54) PIANO HAVING DENSE SOUND-ENHANCING COMPONENT

(76) Inventor: Robert B. DiSanto, Naples, FL (US)

Correspondence Address: EDWARD M. LIVINGSTON, PA, 963 TRAIL TERRACE DRIVE, NAPLES, FL, 34103, US

(21) Appl. No.: 12/137,045

(22) Filed: Jun. 11, 2008

(51) Int. Cl. G10C 3/02; G10C 3/00; G10C 3/04; G10C 3/06; G10C 3/08

(52) U.S. Cl. 84/177; 84/174; 84/186.1; 84/187; 84/199; 84/209; 84/212

(57) ABSTRACT

A piano (1) having a dense sound-enhancing component (2), said piano (1) having a case (6), a frame (3) located within the case (6), strings (5) located within the frame (3), keys (9) in connection with hammers (11), two bridges (13) each of stone having a top face (27), a bottom face (28), a first side (29) and a second side (30), bridge pins (16) extending from the top face (27) at an angle, the strings (5) extending across the bridges (13) adjacent to the bridge pins (16), a soundboard (4) and an amount of epoxy (18) located between the bridges (13) and soundboard (4). The dense sound-enhancing component (2) is a stone material, preferably granite, and enhances the sound of the piano (1) by holding and sustaining pitch longer, providing a longer and stronger signal, providing a higher volume or decibel level and having a decreased decibel fall-off as compared to conventional pianos utilizing wood bridge(s).

### BACKGROUND OF THE INVENTION

This invention relates to pianos, more particularly, a piano having a dense sound-enhancing component that holds and sustains a pitch longer and produces a louder sound as compared to conventional pianos and is not easily affected by changes in air moisture and temperature.

Pianos are comprised of several major parts, including a frame, a soundboard, at least one bridge, a plurality of strings, an action, a plurality of pedals, a plurality of ribs and a case. The frame is the skeleton of cast iron on which the strings are stretched. The soundboard is a softwood resonating agent which vibrates from the percussion on the strings and amplifies the tone. The bridges are made of wood and are located on the front side of the soundboard. The action, which includes the keys and hammers, is located within the case, which is all exterior parts of the piano, such as the lid, sides, arms, music shelf, fallboard, etc., as a whole. The ribs are located on the underside of the soundboard and help to keep the proper forward curve in the soundboard. When the keys are struck, the hammers strike the strings located on the frame. The bass and treble bridges transfer the vibrations of the strings to the soundboard, resulting in tone. Dampers, which are small, felt-covered pieces of wood, rest against the piano strings in normal position. The dampers lift from the strings when a key is struck. When the keys are released, the sound is dampened due to the damper returning to the string, thereby causing the string to stop vibrating.

It is well recognized that wood, in particular aged wood, is the conventionally utilized material for most of the parts of the piano, including the bridges and soundboard. Although wood does, in fact, transmit sound, the sound transmitted is not optimal as when compared to other the sound transmission utilizing other sound transmitting materials, most notably, dense sound-enhancing materials, such as granite or any other type of stone or rock.

A user may not readily hear the lackluster quality of sound transmission when playing a piano having a traditional wood bridge as a user is usually not listening to side-by-side comparisons of pianos but rather just a single conventional piano. However, it should be noted that slow tempo songs are limited to the individual fall-off rate of the instrument, so the tempo is increased to keep the song flowing on a conventional piano as the pitch is only held for a relatively short amount of time. Thus, “dead air” is created when playing a slow tempo tune on the piano, which is not acoustically pleasing. To compensate for the relatively short pitch, oftentimes piano players increase the tempo of a song, thereby eliminating the dead air. Therefore, true slow songs, such as many love songs, are not played on the piano as a solo instrument.

Similarly, although a user may not readily find the volume of a piano to be sub-par. Because conventional pianos utilize wood as a bridge and wood absorbs sound, not all of the sound is transmitted, thereby decreasing the sound output as when compared to utilizing a bridge that does not absorb sound.

Additionally, another flaw in the use of wood in a piano, particularly on the bridge and soundboard, relates to sensitivity of wood with respect to air moisture and air temperature. As is commonly known, wood expands when exposed to high moisture content and air temperature and contracts when the air moisture and temperature are decreased. High moisture content will swell the moving parts of the piano, thereby causing it to be sluggish, whereas low moisture content will shrink the parts, making the touch weak and rattling. Extreme fluctuations in heat and moisture may cause the wood to deteriorate and eventually crack, thereby causing the glue joints to fail. The only way to restore a piano once these critical wood parts have deteriorated is via a costly repair wherein the deteriorated parts are replaced.

Thus, a need exists for a piano having a dense sound-enhancing component that holds and sustains a pitch longer and produces a louder sound as compared to conventional pianos and is not easily affected by changes in air moisture and temperature.

The relevant prior art includes the following references:

| Patent/App. No. | | |
|---|---|---|
| (U.S. unless stated otherwise) | Inventor | Issue/Publication Date |
| 5,267,499 | Othon | December 1993 |
| 6,296,902 | Parra Soriano | October 2001 |
| 5,253,932 | Nesovic | October 1993 |
| 5,004,512 | Fodera | April 1991 |
| 3,878,030 | Cook | April 1975 |
| 3,915,935 | Abraham et al. | October 1975 |
| 6,286,215 | Panaccione | September 2001 |
| 5,597,627 | Lindeberg | January 1997 |
| 4,810,533 | Smith | March 1989 |

### SUMMARY OF THE INVENTION

The primary object of the present invention is to provide a piano having a dense sound-enhancing component that holds and sustains a pitch longer as compared to conventional pianos.

Another object of the present invention is to provide a piano having a dense sound-enhancing component that produces a longer, and therefore stronger, signal as compared to conventional pianos, thereby resulting in a louder sound or decibel level as compared to conventional pianos.

An even further object of the present invention is to provide a piano having a dense sound-enhancing component that has a lower decibel fall-off as compared to conventional pianos.

A further object of the present invention is to provide a piano having a dense sound-enhancing component that is not easily affected by changes in air moisture and temperature.

Another object of the present invention is to provide a piano having a dense sound-enhancing component that requires less tuning as compared to conventional pianos.

An even further object of the present invention is to provide a piano having a dense sound-enhancing component that virtually eliminates cracking of a bridge over time.

The present invention fulfills the above and other objects by providing a piano having at least one dense sound-enhancing component, said piano having a case of a predetermined size and shape, a frame located within said case, at least one string extending a predetermined distance within said frame, at least one key in connection with at least one hammer wherein said at least one hammer strikes said at least one string when said at least one key is struck, at least one bridge of a predetermined dense sound-enhancing material, said at least one bridge having a top face, a bottom face, a first side and a second side, said at least one bridge having at least one bridge pin extending from said top face, said at least one string over across said at least one bridge and is adjacent to said at least one bridge pin, at least one soundboard located within said case and located below said frame and at least one contacting means for contacting said at least one bridge to said at least one soundboard. The dense sound-enhancing component, which is a stone material, preferably granite, enhances the sound of the piano by holding and sustaining pitch longer, providing a longer and stronger signal, providing a higher volume or decibel level and having a decreased decibel fall-off as compared to conventional pianos utilizing wood bridge(s). The contacting means is preferably epoxy, specifically penetrating epoxy, so as to eliminate buzz or vibration. The bridge(s) may also include a plurality of slopes and knurls to accommodate the strings.

Not only may the dense sound-enhancing component be in the form of at least one bridge, but it may also be in the form of a soundboard, at least one rib, an internal and/or external edge of a case and/or a lid of a piano.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

FIG. 1 is an exploded top perspective view of a piano having a dense sound-enhancing component of the present invention in the form of a bridge and soundboard;

FIG. 2 is a top close-up view of a portion of a dense sound-enhancing component of the present invention of FIG. 1;

FIG. 3 is a side view of the dense sound-enhancing component of FIG. 2;

FIG. 4 is a cross-sectional plan view along line 4-4 of the embodiment of FIG. 3;

FIG. 5 is bottom view of a piano having a dense sound-enhancing component of the present invention in the form of ribs; and

FIG. 6 is a side view of a piano having a dense sound-enhancing component of the present invention in the forms of an internal edge of a case, an external edge of a case and a lid.

### DESCRIPTION OF THE PREFERRED EMBODIMENTS

For purposes of describing the preferred embodiment, the terminology used in reference to the numbered components in the drawings is as follows:

| | |
|---|---|
| 1. | piano |
| 2. | dense sound-enhancing |
| | component, generally |
| 3. | frame |
| 4. | soundboard |
| 5. | strings |
| 6. | case |
| 7. | pedals |
| 8. | action |
| 9. | keys |
| 10. | ribs |
| 11. | hammers |
| 12. | lid |
| 13. | bridge, generally |
| 14. | bass bridge |
| 15. | treble bridge |
| 16. | bridge pin |
| 17. | contacting means |
| 18. | epoxy |
| 19. | slope |
| 20. | knurl |
| 21. | internal edge |
| 22. | external edge |
| 23. | leg |
| 24. | securing means |
| 25. | bolt |
| 26. | washer |
| 27. | top face |
| 28. | bottom face |
| 29. | first side |
| 30. | second side |

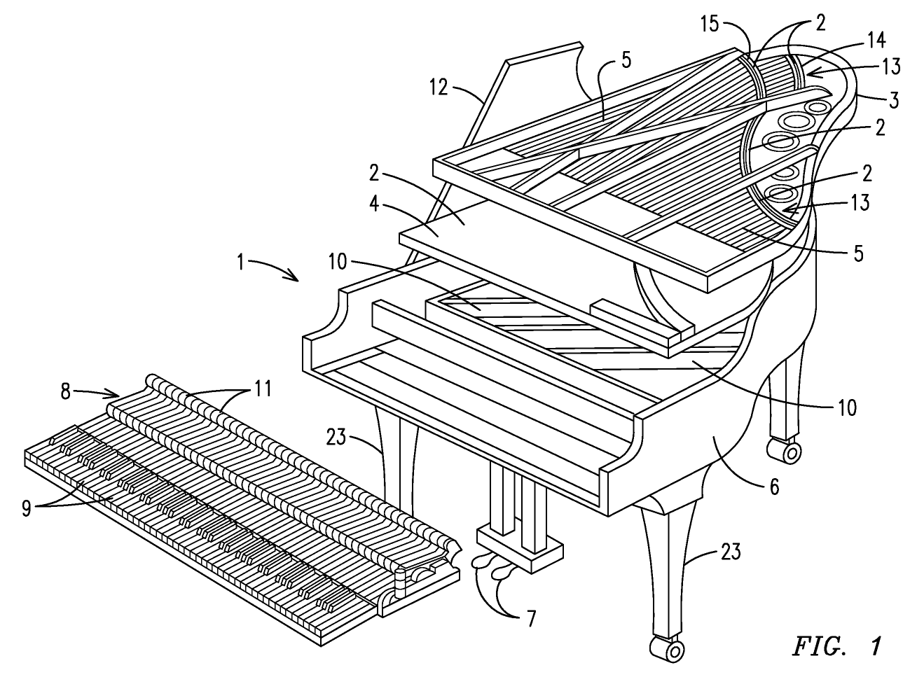

With reference to FIG. 1, an exploded top perspective view of a piano having a dense sound-enhancing component of the present invention in the form of a bridge is shown. The piano 1 includes all of the standard components of a conventional piano 1, including a case 6, a frame 3 located within the case 6, a plurality of strings 5 extending a predetermined distance within the frame 3, an action 8, including keys 9 in connection with hammers 11, wherein the hammers 11 strike the strings 5 when the keys 9 are struck, a bridge, generally 13, and, more particularly, a bass bridge 14 and a treble bridge 15, pedals 7, a soundboard 4 located within the case 6 and below the frame 3, a plurality of ribs 10 extending across the case 6, legs 23 and a lid 12.

As shown in FIG. 1, the dense sound-enhancing component 2 is in the form of a bridge 13, more particularly, the bass bridge 14 and the treble bridge 15, wherein the bridges 14 and 15 are of stone, preferably granite, as granite is hard and extremely durable and the extreme density and hardness of granite are factors in granite having a high vibrating sound transmission speed. The various granites, typically identified by their color such as black absolute, tiger eye, etc., have different acoustical properties and, therefore, resonate slightly different sounds when utilized in a piano 1. In particular, granite with its wide range of colors, density and composition offers a broad spectrum of acoustical benefit options for sound enhancement. In addition, it has been found that the extreme density and hardness of granite and quartzite make them an optimal material for high sound transmission speed and produces results that are superior to those attained with less dense stone or synthetic materials. Granite is also preferred for its very low moisture absorption properties. It should be noted, however, that the term stone is used herein to include such materials as granite, marble, quartzite, limestone, terrazzo, soapstone, porphyry, agglomerate, cobblestone, slate, semi-precious stones and any other type of stone or rock.

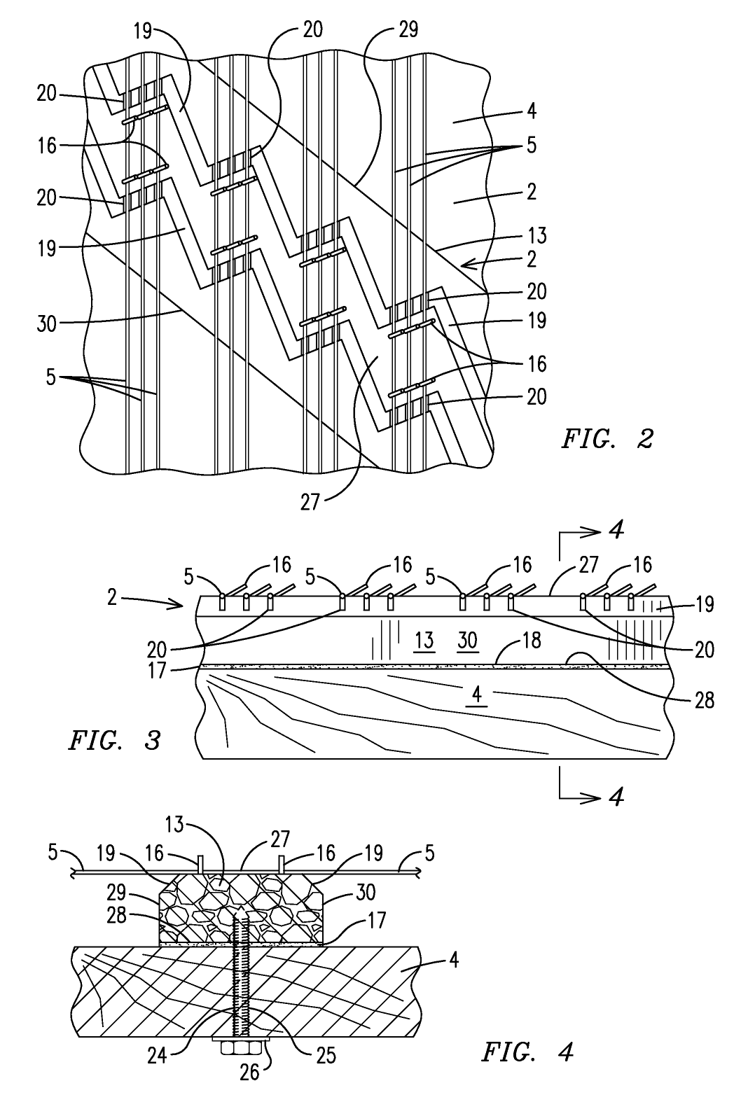

With respect to FIGS. 2-4, varying views of a close-up view of a portion of the dense sound-enhancing component of FIG. 1 are shown. The bridge 13 has a top face 27, a bottom face 28, a first side 29 and a second side 30 and includes at least one bridge pin 16 extending from the top face 27 at a predetermined angle, which is preferably approximately thirty degrees. The strings 5 extend over the bridge 13 and are adjacent to the bridge pin 16.

The bridge 13 preferably includes at least one slope 19 wherein a slope 19 extends from the top face 27 to the first side 29 and another slope 19 extends from the top face 27 to the second side 30. At least one knurl 20 is preferably provided in the top face 27 of the bridge 13 such that a string 5 may be accommodated therein. The inclusion of such slopes 19 and knurls 20, also referred to as “chipping”, is to prevent the strings 5 from touching and wearing down the bridge 13.

The bottom face 28 of the bridge 13 is attached to the soundboard 4. In order to reduce and/or eliminate vibration/buzzing by direct contact of the bridge 13 and the soundboard 14, at least one contacting means 17 is located between the bridge 13 and the soundboard 4. The bottom face 28 and soundboard 4 are substantially flat with minimal clearance tolerances so that only small amount of contacting means 17 is necessary for bonding the surfaces together. The usage of the contacting means 17 is to “ground” and connect the bridge 13 to the soundboard 4 so that an optimal sound transmission is obtained. The at least one contacting means 17 is preferably epoxy 18, specifically a penetrating epoxy 18, that fills in any gaps between the bridge 13 and the soundboard 4.

At least one securing means 24 is provided so as to secure the bridge 13 to the soundboard 4. The at least one securing means 24 is preferably in the form of at least one bolt 25 and washer 26 wherein the bolt 25 extends through the bottom of the soundboard 4 and into the bottom face 28 of the bridge 13 a predetermined distance into the bridge 13. An optional washer 26 may be located between the head of the bolt 25 and the soundboard 4 so as to provide a barrier between the head of the bolt 25 and soundboard 4. Although the at least one securing means 24 is shown in the form of a bolt 25 and washer 26, other securing means 24 may be used.

Next, FIG. 5 shows a bottom view of a piano having a dense sound-enhancing component of the present invention in the form of ribs. Ribs 10 are located within the case 6 and below the soundboard 4 and extend a predetermined distance across the soundboard 4 to keep a proper forward curve in the soundboard 4. The dense sound-enhancing component 2 may be in the form of at least one rib 10 so as to enhance the acoustic properties of a piano 1 wherein the dense sound-enhancing component 2 is stone.

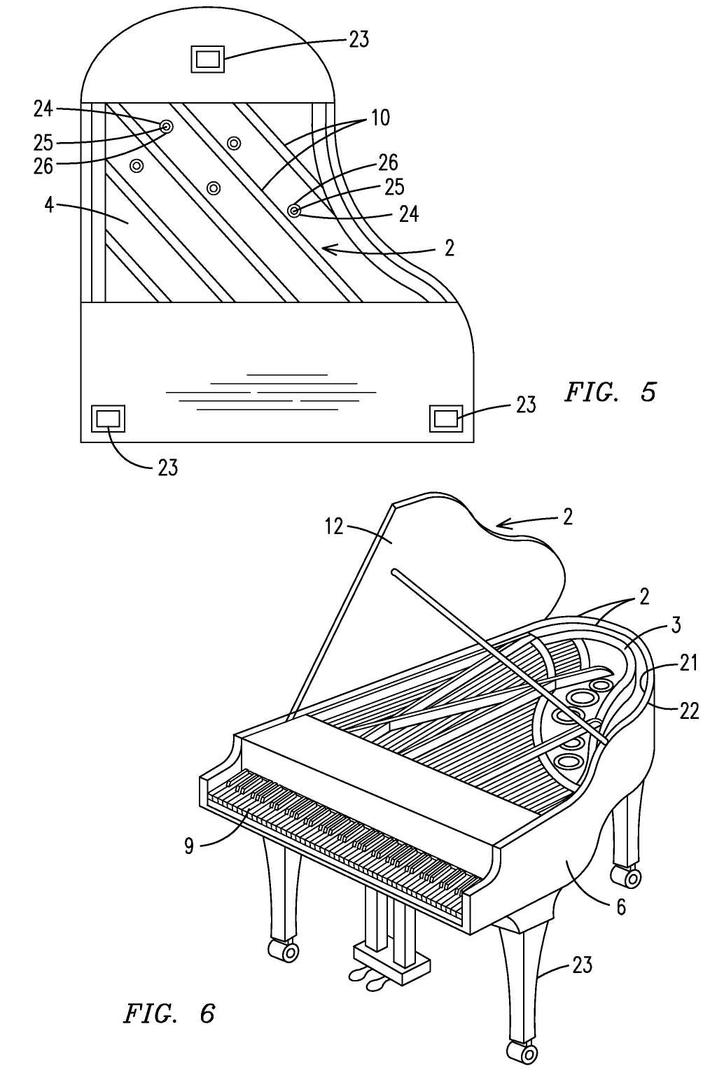

Finally, FIG. 6 is a side view of a piano having a dense sound-enhancing component of the present invention in the forms of an internal edge of a case, an external edge of a case and a lid. The acoustical benefits resulting from utilizing the dense sound-enhancing component 2 of the present invention in the forms of an internal edge 21 and external edge 22 of a case 6 and in the form of a lid 12 are the similar to those reaped when the dense sound-enhancing component 2 is the in the form of a bridge 13 or soundboard 4; that is, much more precise, clear, louder and overall better sound.

Some of the acoustical benefits resulting from the dense sound-enhancing component 2 of the present invention includes a pitch that is held and sustained longer, a lower decibel fall-off and a stronger and longer signal that results in a louder sound as compared to conventional pianos 1 utilizing wood components.

First, with respect to pitch, losing pitch is not desirable to a listener as it is akin to a singer hitting a high note and then “going flat” while holding that note. When the dense sound-enhancing component 2 is utilized in a piano 1, particularly the bridge 13 and/or soundboard 4, the tone is stronger at the soundboard 4 as the pitch created is held and sustained for a longer amount of time prior to descending as compared to pianos 1 without the dense sound-enhancing component 2 of the present invention.

Second, with respect to decibel fall-off, a conventional piano 1 without the inclusion of a dense sound-enhancing component 1 has a fall-off anywhere from around 23 decibels to around 32 decibels. The lower the decibel number, the longer a note is held and audible to a listener. Thus, in order for pianists to play a slow song, he/she must be aware of the decibel fall-off and essentially speed-up the song so as to compensate for the fall-off so as to keep the song flowing and sound continuous. When the dense sound-enhancing component 2 of the present invention is utilized, the fall-off sound is lowered, thereby allowing for slow, continuous piano 1 playing with less fall-off sound and without the need to speed-up the song.

Third, acoustic pianos 1 double and triple the amount of strings 5 per key 9 to produce a sound loud enough to be acceptable to a listener's ear. Without doing so, the piano sounds “thin.” Although piano manufacturers have created 2-string pianos, these pianos have failed to perform as well as 3-string pianos and, accordingly, have not sold as well as the 3-string pianos.

When the dense sound-enhancing component 2 of the present invention is utilized, particularly in the form of a bridge 13, the sound is louder at the soundboard 4 and the signal sustains longer as compared to conventional pianos 1 of the same size, as well as to conventional pianos 1 that are larger in size. Because the strength of the signal and sustaining power provided through the use of the dense sound-enhancing component 2 of the present invention, a lesser number of strings 5 per key 9 is needed to produce a pleasing tone. Thus, the inclusion of dense sound-enhancing components of a piano (e.g., bridges 13, soundboards 4, ribs 10, edges 21 and 22, lids 12, etc.), such as stone materials, produces dramatic enhancement to the musical instrument's sound qualities.

In addition, manufacturer's costs are decreased as less cast iron will be needed for the frame 3 to support the approximately forty thousand (40,000) pounds of pressure that it must withstand when 3-string 5 keys 9 are utilized. In addition, fewer materials, such as tuning pins, strings 5, heavy wood framing will be used, thereby decreasing costs. In addition, the costs associated with tuning the piano 1 are decreased as less tunings are necessitated. Moreover, shipping costs are also reduced due to decreased weight and parts.

Moreover, because conventional pianos having wooden components, such as the bridge(s), soundboard, ribs, internal and external edges of the case and/or lid, are sensitive to humidity changes due to wood being hygroscopic, the use of dense sound-enhancing components 2, such as a stone material and particularly granite, in place of critical wooden components can render pianos acoustically insensitive to humidity changes. Thus, because the dense sound-enhancing component does not expand and contract when exposed to moisture and/or temperature fluctuations, a tuning will hold longer as the dense sound-enhancing component 2 will not split over time.

Not only may the dense sound-enhancing component 2 be in the form of a bridge 13, but it may be in the form of a soundboard 4 as well. The soundboard 4 is a critical element of the piano 1 and it is believed that the tonal output of any piano 1, with no cracks in the soundboard 4 at all, is subject to vastly greater change with every change in temperature and humidity. The alternate absorption and evaporation of moisture affects the soundboard 4, and therefore the tone of the piano 1, to a far greater degree than any crack or accumulation of cracks. The use of a very low porosity stone, in particular, granite, significantly counters this problem by virtue of the very low sensitivity to moisture and temperature.

There are two primary considerations in selecting the dense sound-enhancing component 2 to be used: (i) acoustical benefits—the sound resonation characteristics of the selected stone, and (ii) aesthetic benefits—the appearance, color, and veining patterns of the selected material.

1. Rock and Rock Formation

Rocks are classified into three major classes, each according to the geological process from which they evolve: igneous, sedimentary, and metamorphic. Igneous rocks are formed from molten magna. When the magma cools and solidifies above the earth's surface, it is called extrusive or volcanic rock or lava. When the magma cools below the surface, it is called intrusive or plutonic rock. The rock adjacent to these intrusions is transformed by the hot gases, liquids and vapors generated by the magma. Thus, the mineral composition and structure of an adjacent limestone formation will be transformed into a higher grade of marble. Plutonic rock has solidified at depth under great pressure and is composed of an interlocking crystalline matrix of visible mineral grains large enough to be seen. Often the different mineral crystals contrast with each other to provide a magnificent visual effect. The lattice structures (crystallographic forms) taken by these chemical components are numerous and are determined by the type and quantity of minerals present and the pressure and temperature of the environment in which they evolve.

Note: Many minerals are polymorphic. That is, though their chemical composition is the same, they may evolve into two or more physically distinct crystal forms, depending upon the environment in which they are precipitated (e.g., calcium carbonate precipitates as both aragonite and calcite). Generally, all plutonic rocks can take a polish and are often mistaken for marble. Examples of plutonic rock used for decorative purposes include: granite, quartzite, syenite, diorite, monzonite, granodiorate, gabbo and diabase (black granite).

Sedimentary rock is formed from the minerals and rock debris of igneous rocks as they are broken down over the ages by geological processes. Sedimentary rocks can be thought of as the foundation for natures formation of marble.

Metamorphic rock is formed from sedimentary or igneous rock that has been subjected to intense pressure and/or temperature that has transformed its crystalline structure/texture, density, coloring, and other characteristics.

2. Composition and Resonance Qualities of Granite

Although all rock offers unique appearance and resonance qualities, we have selected the granites, by way of example, to discuss in this regard, because of its broad range of colors, appearance, density, and resonance qualities.

Granite is quarried in a wide array of colors and patterns from all over the world and, generally, is composed of four basic crystallized minerals:

Quartz—consists of silica or gold;

Mica—glittering mineral of scales or plates formed from imploding and cooling over and over;

Feldspars—crystalline mineral forming granite and other rocks; and

Hornblende—mineral composed of silica, magnesia, lime, or iron.

Typical granite colors and mineral composition categorizes into three color groups (light, medium and dark) some of the most popular granites and, further, describes the typical mineral composition of each color group.

Light Color/Minerals: The light granites consist of a lot of quartz like minerals that are more flexible and mixed with crystalline type minerals that make these granites soft and less dense. The majority of the minerals in the lighter granites are softer and more absorbent than are found in the medium and dark granites. These “soft” granites tend to mildly complement and enhance the existing musical instruments sound qualities, resonance and sustain.

Medium Color/Minerals: The medium granites consist of a higher percentage of quartz, feldspars and magna than the lighter group. There is a much wider variety of color and composition in this grouping than any other group. In addition, many of the granites in this grouping have dark tones mixed in with the more common earth tones. These granites in particular tend to lend more clarify and resonance to the low bass tones. A general enhancement to the full range of tones is quite noticeable with the use of this grouping of granites.

Dark Color/Minerals: The dark color granites consist of large amounts of lava or magma. These dark mineral granites are the densest and heaviest materials available in the granite spectrum. We now know that from the dark, dense granites resonates a distinctive big bass sound and, thus, these colors are used to enhance the deeper, base tones of musical instruments.

The use of the present invention will yield pianos that hold and sustain a pitch longer and produce a louder sound as compared to conventional pianos and will not easily be affected by changes in air moisture and temperature.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A piano having a dense sound-enhancing component comprising:
a piano having a case of a predetermined size and shape;
a frame located within said case;
at least one string extending a predetermined distance within said frame;
at least one key in connection with at least one hammer wherein said at least one hammer strikes said at least one string when said at least one key is struck;
at least one bridge of a predetermined dense sound-enhancing component;
said at least one bridge having a top face, a bottom face, a first side and a second side;
said at least one bridge having at least one bridge pin extending from said top face;
said at least one string extends over said at least one bridge and is adjacent to said at least one bridge pin;
at least one soundboard located within said case and located below said frame; and
at least one contacting means located between said at least one bridge and said at least one soundboard for contacting said at least one bridge to said at least one soundboard.

2. The piano having a dense sound-enhancing component of claim 1 wherein:
said at least one dense sound-enhancing component is stone.

3. The piano having a dense sound-enhancing component of claim 2 wherein:
said stone is granite.

4. The piano having a dense sound-enhancing component of claim 2 wherein:
said stone is semi-precious stone.

5. The piano having a dense sound-enhancing component of claim 1 wherein:
said at least one contacting means is a predetermined amount of epoxy.

6. The piano having a dense sound-enhancing component of claim 2 wherein:
said at least one contacting means is a predetermined amount of epoxy.

7. The piano having a dense sound-enhancing component of claim 3 wherein:
said at least one contacting means is a predetermined amount of epoxy.

8. The piano having a dense sound-enhancing component of claim 4 wherein:
said at least one contacting means is a predetermined amount of epoxy.

9. The piano having a dense sound-enhancing component of claim 1 wherein:
said at least one bridge pin extends from said at least one bridge top face at a predetermined angle.

10. The piano having a dense sound-enhancing component of claim 2 wherein:
said at least one bridge pin extends from said at least one bridge top face at a predetermined angle.

11. The piano having a dense sound-enhancing component of claim 3 wherein:
said at least one bridge pin extends from said at least one bridge top face at a predetermined angle.

12. The piano having a dense sound-enhancing component of claim 4 wherein:
said at least one bridge pin extends from said at least one bridge top face at a predetermined angle.

13. The piano having a dense sound-enhancing component of claim 1 further comprising:
at least one slope extending from said at least one bridge top face to said at least one bridge first side.

14. The piano having a dense sound-enhancing component of claim 13 further comprising:
at least one slope extending from said at least one bridge top face to said at least one bridge second side.

15. The piano having a dense sound-enhancing component of claim 2 further comprising:
at least one slope extending from said at least one bridge top face to said at least one bridge first side.

16. The piano having a dense sound-enhancing component of claim 15 further comprising:
at least one slope extending from said at least one bridge top face to said at least one bridge second side.

17. The piano having a dense sound-enhancing component of claim 1 further comprising:
at least one knurl located on said at least one bridge top face wherein said at least one knurl accommodates said at least one string when said at least one string extends over said at least one bridge.

18. The piano having a dense sound-enhancing component of claim 2 further comprising:
at least one knurl located on said at least one bridge top face wherein said at least one knurl accommodates said at least one string when said at least one string extends over said at least one bridge.

19. The piano having a dense sound-enhancing component of claim 1 wherein:
said at least one soundboard is stone.

20. The piano having a dense sound-enhancing component of claim 2 wherein:
said at least one soundboard is stone.

21. The piano having a dense sound-enhancing component of claim 1 further comprising:
at least one rib located within said case;
said at least one rib is located below said at least one soundboard and extends a predetermined distance across said at least one soundboard; and
said at least one rib is stone.

22. The piano having a dense sound-enhancing component of claim 2 further comprising:
at least one rib located within said case;
said at least one rib is located below said at least one soundboard and extends a predetermined distance across said at least one soundboard; and
said at least one rib is stone.

23. The piano having a dense sound-enhancing component of claim 1 further comprising:
an internal edge and an external edge located on said case;
said internal edge is stone; and
said external edge is stone.

24. The piano having a dense sound-enhancing component of claim 2 further comprising:
an internal edge and an external edge located on said case;
said internal edge is stone; and
said external edge is stone.

25. The piano having a dense sound-enhancing component of claim 1 further comprising:
a lid secured to said case; and
said lid is stone.

26. The piano having a dense sound-enhancing component of claim 2 further comprising:
a lid secured to said case; and
said lid is stone.

27. The piano having a dense sound-enhancing component of claim 1 further comprising:
at least one securing means for securing said at least one bridge to said at least one soundboard.

28. The piano having a dense sound-enhancing component of claim 2 further comprising:
at least one securing means for securing said at least one bridge to said at least one soundboard.

29. The piano having a dense sound-enhancing component of claim 27 wherein:
said at least one securing means for securing said at least one bridge to said at least one soundboard is at least one bolt.

30. The piano having a dense sound-enhancing component of claim 28 wherein:
said at least one securing means for securing said at least one bridge to said at least one soundboard is at least one bolt.

31. A piano having a dense sound-enhancing component comprising:
a piano having a case of a predetermined size and shape;
a frame located within said case;
at least one string extending a predetermined distance within said frame;
at least one key in connection with at least one hammer wherein said at least one hammer strikes said at least one string when said at least one key is struck;
at least one bridge of stone;
said at least one bridge having a top face, a bottom face, a first side and a second side;
at least one bridge pin extending from said at least one bridge top face at a predetermined angle;
said at least one string extends over said at least one bridge and is adjacent to said at least one bridge pin;
at least one knurl located on said at least one bridge top face wherein said at least one knurl accommodates said at least one string when said at least one string extends over said at least one bridge;
at least one soundboard located within said case and located below said frame;
at least one contacting means located between said at least one bridge and said at least one soundboard for contacting said at least one bridge to said at least one soundboard; and
at least one securing means for securing said at least one bridge to said at least one soundboard.

32. The piano having a dense sound-enhancing component of claim 31 wherein:
said at least one contacting means is a predetermined amount of epoxy.

33. The piano having a dense sound-enhancing component of claim 32 wherein:
said at least one securing means is at least one bolt.

34. A piano having a dense sound-enhancing component comprising:
a piano having a case of a predetermined size and shape;
a frame located within said case;
at least one string extending a predetermined distance within said frame;
at least one key in connection with at least one hammer wherein said at least one hammer strikes said at least one string when said at least one key is struck;
at least one bridge of stone;
said at least one bridge having a top face, a bottom face, a first side and a second side;
at least one slope extending from said at least one bridge top face to said at least one bridge first side;
at least one slope extending from said at least one bridge top face to said at least one bridge second side;
at least one bridge pin extending from said at least one bridge top face at a predetermined angle;
said at least one string extends over said at least one bridge and is adjacent to said at least one bridge pin;
at least one knurl located on said at least one bridge top face wherein said at least one knurl accommodates said at least one string when said at least one string extends over said at least one bridge;
at least one soundboard located within said case and located below said frame;
at least one rib located within said case;
said at least one rib is located below said at least one soundboard and extends a predetermined distance across said at least one soundboard;
a predetermined amount of epoxy located between said at least one bridge and said at least one soundboard for contacting said at least one bridge to said at least one soundboard; and
at least one bolt for securing said at least one bridge to said at least one soundboard.
